(19) United States
(12) Patent Application Publication
(10) Pub. No.: US 2026/0319345 A1
(43) Pub. Date: Oct. 15, 2026

(54) 360-DEGREE PHOTO BOOTH

(71) Applicant: MARVEL TECHNOLOGY(CHINA) CO., LTD, SHENZHEN (CN)

(72) Inventors: HAI HUANG, SHENZHEN (CN); JIYUAN WEI, SHENZHEN (CN)

(21) Appl. No.: 19/688,987

(22) Filed: May 27, 2026

Related U.S. Application Data
(63) Continuation of application No. PCT/CN2024/137653, filed on Dec. 7, 2024.

(30) Foreign Application Priority Data
Nov. 28, 2023 (CN) 202323215007.9

(51) Int. Cl. G03B 17/56; G03B 37/02

(52) U.S. Cl. CPC G03B 17/561; G03B 37/02

(57) ABSTRACT

A 360-degree photo booth includes a supporting stage, a power supply module, a driving device, a rotating shooting stand, and an electrical conductor. A first end of the rotating shooting stand is connected to a power output end of the driving device, and a second end of the rotating shooting stand is configured for mounting at least one shooting device. The driving device is configured to drive the rotating shooting stand to move around the supporting stage. The electrical conductor is electrically connected to the power supply module and configured to transmit electrical energy to the at least one shooting device mounted on the rotating shooting stand. The power supply module is installed on the supporting stage. The electrical conductor includes a brush assembly, a first conductive ring connected to a lower end surface of the supporting stage, a second conductive ring, and a connecting wire.

### TECHNICAL FIELD

The present disclosure relates to a technical field of shooting devices, and in particular to a 360-degree photo booth.

### BACKGROUND

As an emerging piece of filming equipment, a 360-degree photo booth is highly favored and actively used by groups such as fashionistas, celebrities, internet streamers, and variety shows. People use the 360-degree photo booth to create various cool and creative works that amaze audiences. The 360-degree photo booth also attracts more and more people who have never experienced it to give it a try.

Currently, a majority of users use their own smartphones as shooting devices, but many also choose more professional cameras and install the professional cameras on a rotating shooting stand of the 360-degree photo booth. When a shooting device is in operation, the video capture of a camera thereof, screen display, high-speed writing of a storage chip thereof, and a computational processing of a processor thereof are inherently power-consuming processes. Furthermore, with an introduction of peripherals such as microphones and fill lights, as well as functions like live streaming and real-time image rendering, a limited battery capacity of the shooting device is difficult to support the shooting device for long periods of operation. As a result, a battery of the shooting device easily runs out, thereby limiting a duration of filming and making it difficult for users to fully utilize the 360-degree photo booth for recording works and live streaming.

### SUMMARY

In view of defects in the prior art, the present disclosure provides a 360-degree photo booth to solve technical problems in the prior art.

To achieve the above object, the present disclosure provides the 360-degree photo booth. The 360-degree photo booth comprises a supporting stage, a power supply module, a driving device, a rotating shooting stand, and an electrical conductor. A first end of the rotating shooting stand is connected to a power output end of the driving device, and a second end of the rotating shooting stand is configured for mounting at least one shooting device. The driving device is configured to drive the rotating shooting stand to move around the supporting stage. The electrical conductor is electrically connected to the power supply module and configured to transmit electrical energy to the at least one shooting device mounted on the rotating shooting stand.

In one embodiment, the power supply module is installed on the supporting stage he electrical conductor comprises a brush assembly, a first conductive ring, a second conductive ring, and a connecting wire. The first conductive ring and the second conductive ring are connected to a lower end surface of the supporting stage. The first conductive ring and the second conductive ring are respectively connected to a positive terminal and a negative terminal of at least one power output end of the power supply module. The brush assembly is installed on the rotating shooting stand, and two elastic brush ends of the brush assembly respectively abut against the first conductive ring and the second conductive ring. The connecting wire is arranged along a length direction of the rotating shooting stand. A first end of the connecting wire is electrically connected to a power output end of the brush assembly. A charging plug matched with a charging interface of the at least one shooting device is disposed on a second end of the connecting wire. Central axes of the first conductive ring and the second conductive ring are substantially collinear with a central axis of the supporting stage and a rotating central axis of the rotating shooting stand.

In one embodiment, the power supply module comprises at least one solar panel he supporting stage comprises a supporting frame and a light-transmitting supporting layer. T he at least one solar panel is disposed between the supporting frame and the light-transmitting supporting layer. The first conductive ring and the second conductive ring are respectively electrically connected to a positive terminal and a negative terminal of a power output end of the at least one solar panel.

In one embodiment, the 360-degree photo booth further comprises a supporting spindle and a supporting base. The supporting base is connected to the supporting stage through the supporting spindle. The power supply module is installed on the supporting base. The driving device is electrically connected to the power supply module.

In one embodiment, the supporting spindle is a hollow shaft. The electrical conductor comprises a brush assembly, a first conductive ring, a second conductive ring, and a connecting wire. The first conductive ring and the second conductive ring are connected to a lower end surface of the supporting stage. The first conductive ring and the second conductive ring are respectively connected to a positive terminal and a negative terminal of at least one power output end of the power supply module through electrical wires passing through an inner hole of the supporting spindle. The brush assembly is installed on the rotating shooting stand. Two elastic brush ends of the brush assembly respectively abut against the first conductive ring and the second conductive ring. The connecting wire is arranged along a length direction of the rotating shooting stand. A first end of the connecting wire is electrically connected to a power output end of the brush assembly. A charging plug matched with a charging interface of the at least one shooting device is disposed on a second end of the connecting wire. Central axes of the first conductive ring and the second conductive ring are substantially collinear with a central axis of the supporting stage, a rotating central axis of the rotating shooting stand, and a central axis of the supporting spindle.

In one embodiment, the power supply module comprises at least one solar panel and a battery module installed on the supporting base. The supporting stage comprises a supporting frame and a light-transmitting supporting layer. The at least one solar panel is disposed between the supporting frame and the light-transmitting supporting layer. The first conductive ring and the second conductive ring are respectively electrically connected to a positive terminal and a negative terminal of a power output end of the at least one solar panel.

In one embodiment, the 360-degree photo booth further comprises a supporting base. The power supply module is installed on the supporting base. The driving device is electrically connected to the power supply module, or the driving device is not connected to the power supply module. The electrical conductor comprises a brush assembly, a first conductive ring, a second conductive ring, and a connecting wire. The first conductive ring and the second conductive ring are connected to an upper end surface of the supporting base. The brush assembly is installed on the rotating shooting stand. Two elastic brush ends of the brush assembly respectively abut against the first conductive ring and the second conductive ring. The connecting wire is arranged along a length direction of the rotating shooting stand. A first end of the connecting wire is electrically connected to a power output end of the brush assembly. A charging plug matched with a charging interface of the at least one shooting device is disposed on a second end of the connecting wire. Central axes of the first conductive ring and the second conductive ring are substantially collinear with a central axis of the supporting stage, a central axis of the supporting base, and a rotating central axis of the rotating shooting stand.

In one embodiment, the power supply module is installed on the rotating shooting stand and is disposed adjacent to a connection joint between the rotating shooting stand and the power output end of the driving device. The electrical conductor is an electrical line. The electrical line is arranged along a length direction of the rotating shooting stand. A first end of the electrical line is electrically connected to at least one power output end of the power supply module. A charging plug matched with a charging interface of the at least one shooting device is disposed on a second end of the electrical line.

In one embodiment, the supporting stage further comprises a bearing layer. The bearing layer is laid on an upper end surface of the supporting frame. The bearing layer, a peripheral edge of the supporting frame, and the light-transmitting supporting layer are enclosed to define an installation area. The at least one solar panel is disposed in the installation area.

In one embodiment, the rotating shooting stand comprises a first bracket, a second bracket, and an angle adjustment mechanism. The first bracket and the second bracket are rotatably connected through the angle adjustment mechanism. One end of the second bracket away from the angle adjustment mechanism is connected to the power output end of the driving device. The first bracket comprises one or more shooting device connectors. The angle adjustment mechanism comprises a rotating shaft, an elastic member, a pull pin, and two adjustment bases. A rotating groove is defined between the two adjustment bases. An end of the first bracket extends into the rotating groove, and the rotating shaft passes through the two adjustment bases and the first bracket, so that the first bracket is hinged to the two adjustment bases. The adjustment bases comprise arc-shaped slots. Partition protrusions spaced apart from each other are disposed in each of the arc-shaped slots to divide each of the arc-shaped slots into positioning holes. The first bracket comprises an adjustment guide slot, and the adjustment guide slot extends along a length direction of the first bracket. The pull pin passes through the arc-shaped slots and the adjustment guide slot. An anti-detachment protrusion is disposed on an outer wall of the pull pin located in the first bracket. A size of the anti-detachment protrusion is greater than an aperture of the adjustment guide slot. The elastic member is disposed in the first bracket. Two ends of the elastic member are respectively connected to the rotating shaft and the pull pin for maintaining the pull pin close to the rotating shaft.

In one embodiment, each shooting device connector comprises a protective outer frame, each protective outer frame is rotatably connected to the first bracket, and an elastic holder is disposed in each protective outer frame.

In one embodiment, anti-theft connecting bases are disposed on the supporting base. A first end of each of the anti-theft connecting bases is adjustably connected to the supporting base. A connecting portion configured to be fixed to a ground is disposed on a second end of each of the anti-theft connecting bases.

In one embodiment, the supporting stage further comprises a supporting bracket. The supporting bracket is disposed between the supporting frame and the light-transmitting supporting layer. The supporting bracket is disposed substantially at a central position of the light-transmitting supporting layer. The light-transmitting supporting layer comprises an opaque coating corresponding to the supporting bracket.

Compared with the prior art, the 360-degree photo booth provided by the present disclosure is capable of transmitting the power energy provided by the power supply module to the at least one shooting device mounted on the rotating shooting stand (which is rotated by the driving device) through the electrical conductor, thereby providing power for the at least one shooting device. A user is allowed to use the 360-degree photo booth more conveniently and for a long period of time without worrying about a power depletion of the at least one shooting device that causes limited filming time, which improves a user experience.

### BRIEF DESCRIPTION OF DRAWINGS

FIG. 1 is a schematic diagram of a 360-degree photo booth according to one embodiment of the present disclosure.

FIG. 2 is an exploded schematic diagram of the 360-degree photo booth according to one embodiment of the present disclosure.

FIG. 3 is another exploded schematic diagram of the 360-degree photo booth according to one embodiment of the present disclosure.

FIG. 4 is a partial cross-sectional exploded schematic diagram of the 360-degree photo booth according to one embodiment of the present disclosure.

FIG. 5 is a schematic diagram of a rotating shooting stand of the 360-degree photo booth according to one embodiment of the present disclosure.

FIG. 6 is a partial exploded schematic diagram of the rotating shooting stand of the 360-degree photo booth according to one embodiment of the present disclosure.

FIG. 7 is another partial exploded schematic diagram of the rotating shooting stand of the 360-degree photo booth according to one embodiment of the present disclosure.

FIG. 8 is a partial schematic diagram of an electrical conductor of the 360-degree photo booth according to one embodiment of the present disclosure.

FIG. 9 is a cross-sectional schematic diagram of a brush assembly of the 360-degree photo booth according to one embodiment of the present disclosure.

FIG. 10 is a schematic diagram of a cable organizer of the 360-degree photo booth according to one embodiment of the present disclosure.

FIG. 11 is another exploded schematic diagram of the 360-degree photo booth according to one embodiment of the present disclosure.

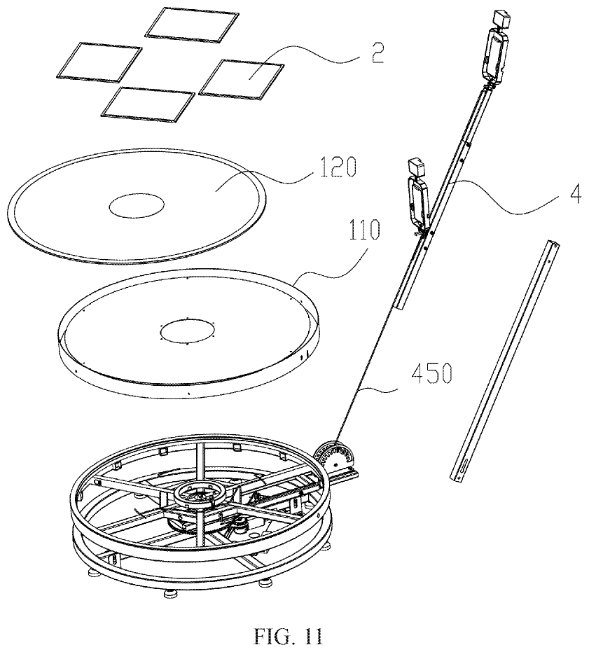

Reference numerals in the drawings: 1—supporting stage; 110—supporting frame; 120—light-transmitting supporting layer; 121—opaque coating; 130—bearing layer; 140—installation area; 150—supporting bracket; 2—power supply module; 3—driving device; 310—bearing; 320—driven wheel; 330—motor; 340—driving wheel; 350—controller; 4—rotating shooting stand; 410—first bracket; 411—adjustment guide slot; 4111—loading hole; 420—second bracket; 430—angle adjustment mechanism; 431—rotating shaft; 432—elastic member; 433—pull pin; 4331—anti-detachment protrusion; 434—adjustment base; 4341—rotating groove; 4342—arc-shaped slot; 4343—partition protrusion; 4344—positioning hole; 440—shooting device connector; 441—protective outer frame; 442—elastic holder; 443—action camera; 450—connecting wire; 5—electrical conductor; 510—first conductive ring; 520—second conductive ring; 530—brush assembly; 531—elastic brush end; 532—mounting box; 540—insulating base; 6—supporting spindle; 7—supporting base; 710—anti-theft connecting base; 711—connecting portion; 720—foot cup; 730—cable tie bridge; 8—routing through hole; 9—cable organizer.

### DETAILED DESCRIPTION

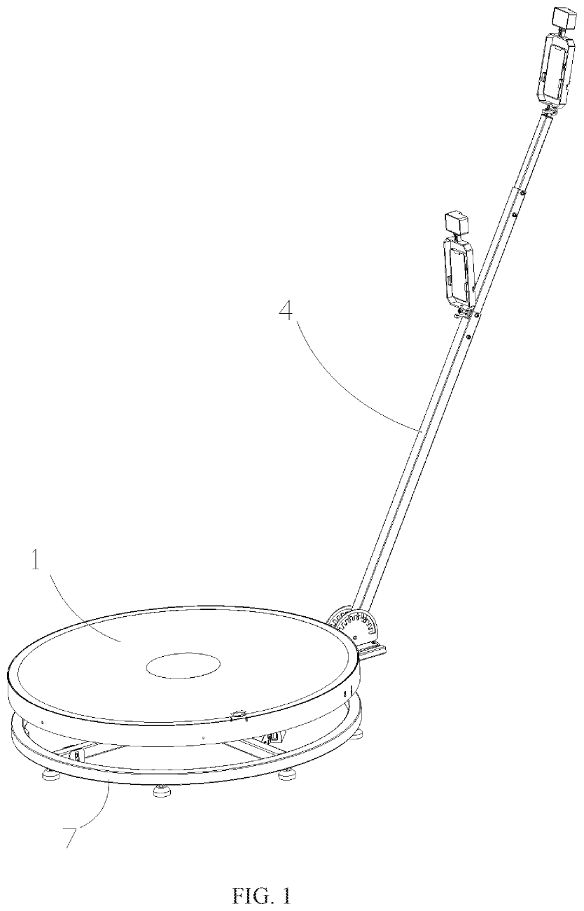

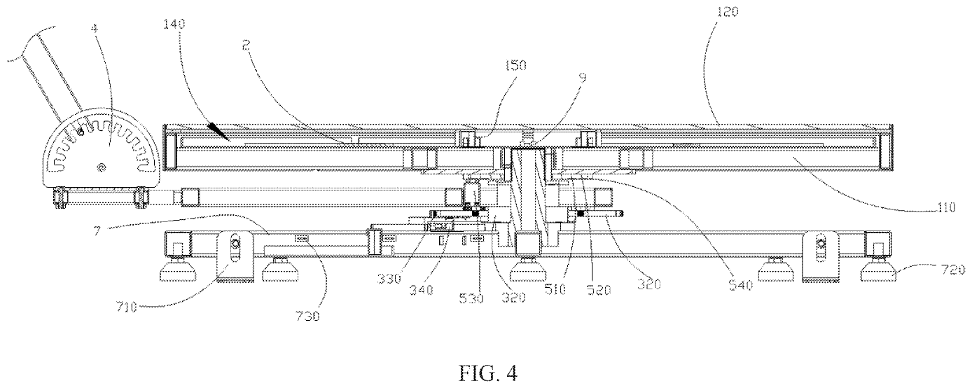

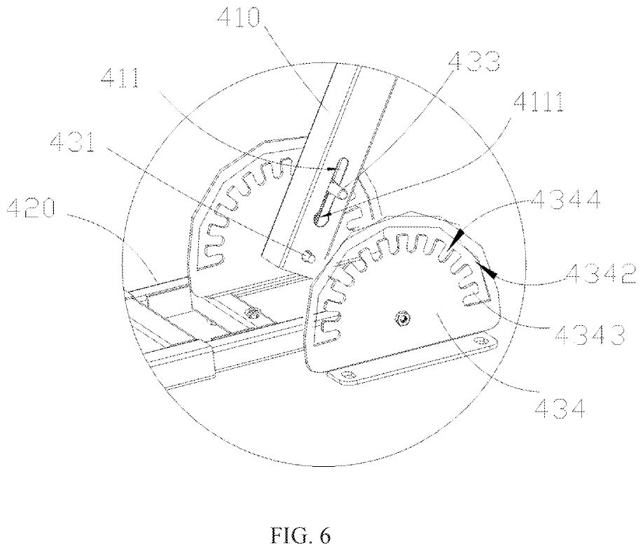

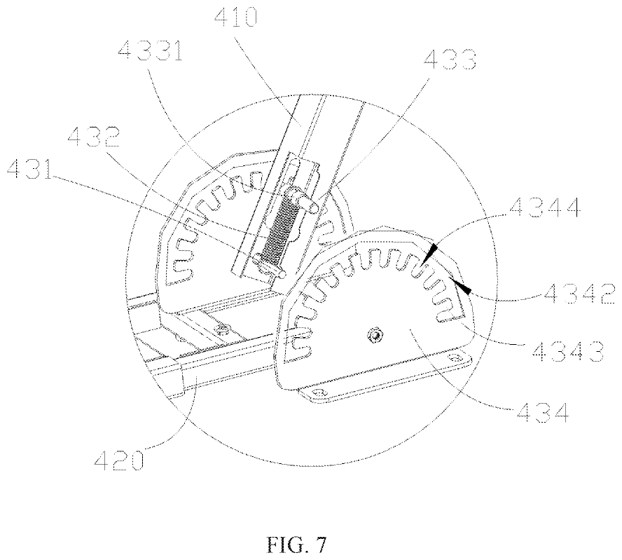

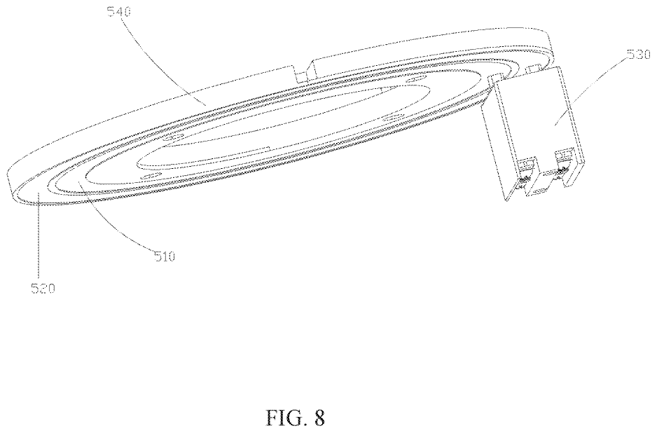

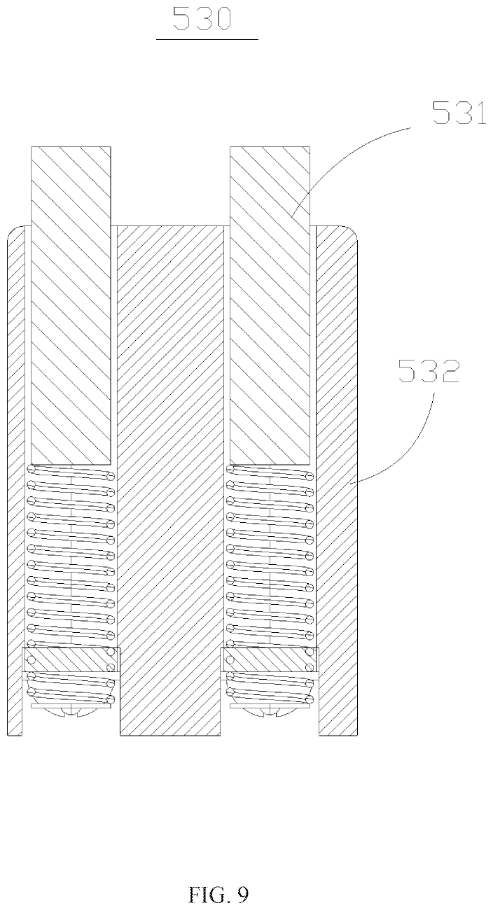

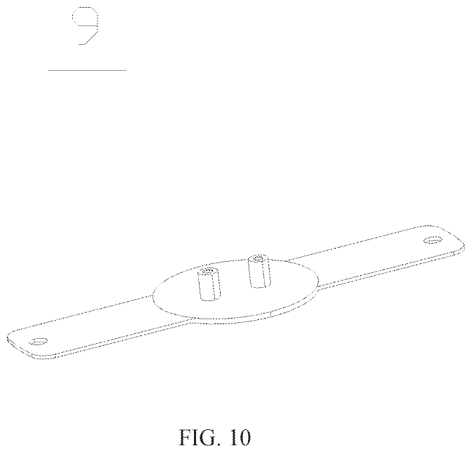

As shown in FIGS. 1-10, embodiments of the present disclosure provide a 360-degree photo booth. The 360-degree photo booth comprises a supporting stage 1, a power supply module 2, a driving device 3, a rotating shooting stand 4, and an electrical conductor 5. A first end of the rotating shooting stand 4 is connected to a power output end of the driving device 3, and a second end of the rotating shooting stand 4 is configured for mounting at least one shooting device. The driving device 3 is configured to drive the rotating shooting stand 4 to move around the supporting stage 1. The electrical conductor 5 is electrically connected to the power supply module 2 and configured to transmit electrical energy to the at least one shooting device mounted on the rotating shooting stand 4.

The supporting stage 1 is configured for a user to stand thereon. The electrical conductor is capable of transmitting the power energy provided by the power supply module to the at least one shooting device mounted on the rotating shooting stand (which is rotated by the driving device) through the electrical conductor, thereby providing power for the at least one shooting device. A user is allowed to use the 360-degree photo booth more conveniently and for a long period of time without worrying about a power depletion of the at least one shooting device that causes limited filming time, which improves a user experience.

### Embodiment 1

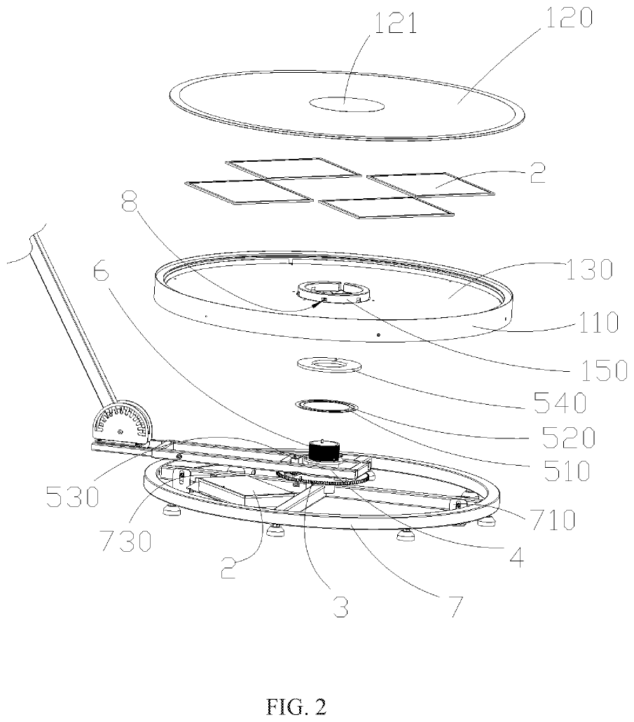

As shown in FIGS. 2-4 and 8, the power supply module 2 is installed on the supporting stage 1. The electrical conductor 5 comprises a brush assembly 530, a first conductive ring 510, a second conductive ring 520, and a connecting wire 450. The first conductive ring 510 and the second conductive ring 520 are connected to a lower end surface of the supporting stage 1.

The first conductive ring 510 and the second conductive ring 520 are respectively connected to a positive terminal and a negative terminal of at least one power output end of the power supply module 2. The brush assembly 530 is installed on the rotating shooting stand 4, and two elastic brush ends 531 of the brush assembly 530 respectively abut against the first conductive ring 510 and the second conductive ring 520. The connecting wire 450 is arranged along a length direction of the rotating shooting stand 4. A first end of the connecting wire 450 is electrically connected to a power output end of the brush assembly 530. A charging plug (not shown) matched with a charging interface of the at least one shooting device is disposed on a second end of the connecting wire 450.

Central axes of the first conductive ring 510 and the second conductive ring 520 are substantially collinear with a central axis of the supporting stage 1 and a rotating central axis of the rotating shooting stand 4.

In the embodiment, the power supply module 2 may be a battery module detachably connected to the supporting stage 1. Maintenance personnel is able to either quickly replace the battery module with a fully charged one on the supporting stage 1 to rapidly replenish electrical energy, or charge the battery module by connecting the 360-degree photo booth to a power outlet through electrical wires when the 360-degree photo booth is not in use.

In some embodiments, the brush assembly 530 comprises a mounting box 532. The two elastic brush ends 531 comprise carbon rods, elastic abutting springs, and wiring bases. The carbon rods are respectively installed in lifting grooves of the mounting box 532. Each of the wiring bases is located at a bottom portion of a corresponding one of the lifting grooves and disposed in a wiring groove. A first end of each of the elastic abutting springs abuts against a corresponding one of the carbon rods, and a second end of each of the elastic abutting springs abuts against a corresponding one of the wiring bases. The connecting wire 450 is connected to the wiring bases. During a process where the brush assembly 530 moves with the rotating shooting stand 4, the carbon rods abut against the first conductive ring 510 and the second conductive ring 520 and undergo wear. Under pressure of the elastic abutting springs, the carbon rods are compensated in position to maintain effective abutting electrical connection with the first conductive ring 510 and the second conductive ring 520 at all times, ensuring that the electrical energy provided by the power supply module 2 is supplied to the at least one shooting device through the electrical conductor 5 combined with the connecting wire 450.

In some embodiments, the first conductive ring 510 and the second conductive ring 520 are both ring-shaped sheets made of copper.

A manner in which the driving device 3 drives the rotating shooting stand 4 to move around the supporting stage 1 is implemented by prior art and is not the focus of the innovation of the present disclosure, and therefore is not described in detail herein.

### Embodiment 2

As shown in FIGS. 2-4 and 8-9, the power supply module 2 comprises at least one solar panel. The supporting stage 1 comprises a supporting frame 110 and a light-transmitting supporting layer 120. The at least one solar panel is disposed between the supporting frame 110 and the light-transmitting supporting layer 120. The first conductive ring 510 and the second conductive ring 520 are respectively electrically connected to a positive terminal and a negative terminal of a power output end of the at least one solar panel.

In one embodiment, the at least one solar panel located on the supporting stage 1 comprises a battery module connected thereto. The electricity generated by the at least one solar panel is first stored in the battery module, and then supplied to the electrical conductor 5 and the at least one shooting device through the battery module.

### Embodiment 3

In the embodiment, the at least one solar panel disposed on the supporting stage 1 does not comprise the battery module, and the generated electrical energy is directly supplied to the at least one shooting device through a steady-current circuit.

In some embodiments, the light-transmitting supporting layer 120 in Embodiments 2 and 3 is tempered glass, so that the supporting stage 1 has good supporting strength, and energy-bearing light (such as sunlight) is allowed to penetrate through the light-transmitting supporting layer 120 and strike the at least one solar panel. The light-transmitting supporting layer 120 may be fully transparent or non-transparent, as long as the light-transmitting supporting layer 120 allows light within the solar spectrum that can be converted into electrical energy by the at least one solar panel to penetrate through.

Configuring the at least one solar panel as a power source is green, environmentally friendly, and promotes energy saving and emission reduction. The 360-degree photo booth equipped with the at least one solar panel is easily applied to entertainment venues as a shared device for public use, eliminating a need for a staff to manage a power supply. In a solar-powered environment, the 360-degree photo booth is able to generate the electrical energy and provide power to itself and the at least one shooting device. Combined with an interactive program, the user is able to start rotating photography and video recording of the 360-degree photo booth by scanning a quick response (QR) code. When the 360-degree photo booth serves as a shared device, the user is able to pay a usage fee via a smart device or by card payment.

As shown in FIGS. 2-4 and 8-9, the 360-degree photo booth further comprises a supporting spindle 6 and a supporting base 7. The supporting base 7 is connected to the supporting stage 1 through the supporting spindle 6. The power supply module 2 is installed on the supporting base 7. The driving device 3 is electrically connected to the power supply module 2.

In some embodiments, the driving device 3 comprises a bearing 310 sleeved on an outer wall of the supporting spindle 6, a driven wheel 320 sleeved on an outer wall of the bearing 310, a motor 330, a driving wheel 340 connected to a power output shaft of the motor 330, and a controller 350. The driving wheel 340 is drivingly connected to the driven wheel 320. The motor 330 and the controller 350 receive electrical energy from the power supply module 2 and are electrically connected to the power supply module 2.

### Embodiment 4

In the embodiment, the power supply module 2 is a battery module detachably connected to the supporting base 7. That is, the power supply module 2 provides charging power to the at least one shooting device mounted on the rotating shooting stand 4 through the electrical conductor 5, and also provides power to the driving device 3, achieving multiple benefits in one go. The maintenance personnel is able to either quickly replace the battery module with a fully charged one on the supporting stage 1 to rapidly replenish electrical energy, or charge the battery module by connecting the 360-degree photo booth to a power outlet through the electrical wires when the 360-degree photo booth is not in use.

### Embodiment 5

In the embodiment, the power supply module 2 is a battery module and also comprises a charging interface. Compared with Embodiment 4 where the fully charged battery module is replaced when the battery module is depleted, the battery module in the embodiment is directly connected to the power outlet via the electrical wires through the charging interface. In this case, the 360-degree photo booth is allowed to be used while charging, with the driving device 3 driving the rotating shooting stand 4 to move around the supporting stage 1 and providing charging power to the at least one shooting device mounted on the rotating shooting stand 4 through the electrical conductor 5. When the battery module is connected to an external power source, the electrical energy from the external power source is preferentially utilized to supply power to the driving device 3 and the at least one shooting device.

As shown in FIGS. 2-4, the supporting spindle 6 is a hollow shaft. The electrical conductor 5 comprises a brush assembly 530, a first conductive ring 510, a second conductive ring 520, and a connecting wire 450. The first conductive ring 510 and the second conductive ring 520 are connected to a lower end surface of the supporting stage 1.

The first conductive ring 510 and the second conductive ring 520 are respectively connected to a positive terminal and a negative terminal of at least one power output end of the power supply module 2 through electrical wires passing through an inner hole of the supporting spindle 6. The brush assembly 530 is installed on the rotating shooting stand 4. Two elastic brush ends 531 of the brush assembly 530 respectively abut against the first conductive ring 510 and the second conductive ring 520. The connecting wire 450 is arranged along a length direction of the rotating shooting stand 4. A first end of the connecting wire 450 is electrically connected to a power output end of the brush assembly 530. A charging plug matched with a charging interface of the at least one shooting device is disposed on a second end of the connecting wire 450.

Central axes of the first conductive ring 510 and the second conductive ring 520 are substantially collinear with a central axis of the supporting stage 1, a rotating central axis of the rotating shooting stand 4, and a central axis of the supporting spindle 6.

### Embodiment 6

In Embodiments 4 and 5, the electrical energy is transmitted from the power supply module 2 disposed on the supporting base 7 to the at least one shooting device mounted on the rotating shooting stand 4 through the electrical conductor 5.

However, in order to avoid a problem of tangling and knotting that is caused by conventional electrical wire configuring as the electrical conductor 5 when the driving device 3 drives the rotating shooting stand 4 to rotate around the supporting stage 1, in the embodiment, the first conductive ring 510 and the second conductive ring 520 of the electrical conductor 5 are connected to a lower end surface of the supporting stage 1. The brush assembly 530 is installed on the rotating shooting stand 4, and electrical wires pass through an inner hole of the supporting spindle 6 to transmit electrical energy from the power supply module 2 to the first conductive ring 510 and the second conductive ring 520. In this way, the electrical wires pass through the inner hole of the supporting spindle 6 without rotating relative to the rotating shooting stand 4, which avoids interference and tangling between the rotating shooting stand 4 and the electrical wires.

For convenience of routing and to reduce a redundant length of the electrical wires, first routing through holes of routing through holes 8 are defined in the supporting base 7 corresponding to a connection junction with the supporting spindle 6. Similarly, second routing through holes of the routing through holes 8 are defined in the supporting frame 110 to facilitate the arrangement of the electrical wires.

### Embodiment 7

In the embodiment, the power supply module 2 comprises at least one solar panel and a battery module installed on the supporting base 7. The supporting stage 1 comprises a supporting frame 110 and a light-transmitting supporting layer 120. The at least one solar panel is disposed between the supporting frame 110 and the light-transmitting supporting layer 120. The first conductive ring 510 and the second conductive ring 520 are respectively electrically connected to a positive terminal and a negative terminal of a power output end of the at least one solar panel.

Compared with Embodiments 4 and 5, the 360-degree photo booth of the embodiment further comprises the at least one solar panel disposed on the supporting stage 1. By providing the at least one solar panel, electricity is generated to replenish the electrical energy of the battery module, thereby extending an operating time of the battery module. Consequently, the maintenance personnel do not need to frequently replace the battery module with the fully charged one, or pull out the power line to connect with the power outlet for charging the battery module, which enhances the user experience.

### Embodiment 8 (Not Shown in the Drawings)

In the embodiment, the 360-degree photo booth further comprises a supporting base 7. The power supply module 2 is installed on the supporting base 7. The driving device 3 is electrically connected to the power supply module 2, or the driving device 3 is not connected to the power supply module 2. The electrical conductor 5 comprises a brush assembly 530, a first conductive ring 510, a second conductive ring 520, and a connecting wire 450. The first conductive ring 510 and the second conductive ring 520 are connected to an upper end surface of the supporting base 7. The brush assembly 530 is installed on the rotating shooting stand 4. Two elastic brush ends 531 of the brush assembly 530 respectively abut against the first conductive ring 510 and the second conductive ring 520. The connecting wire 450 is arranged along a length direction of the rotating shooting stand 4 A first end of the connecting wire 450 is electrically connected to a power output end of the brush assembly 530. A charging plug matched with a charging interface of the at least one shooting device is disposed on a second end of the connecting wire 450.

Central axes of the first conductive ring 510 and the second conductive ring 520 are substantially collinear with a central axis of the supporting stage 1, a central axis of the supporting base 7, and a rotating central axis of the rotating shooting stand 4.

In the embodiment, the two elastic brush ends 531 of the brush assembly 530 face the supporting base 7 and respectively abut against the first conductive ring 510 and the second conductive ring 520 on the supporting base 7. When the 360-degree photo booth is in use, the rotating shooting stand 4 rotates around the supporting stage 1, while the supporting base 7 remains stationary on the ground. By such configurations, the electrical conductor 5 is able to transmit the electrical energy from the power supply module 2 installed on the supporting base 7 to the at least one shooting device mounted on the rotating shooting stand 4 without interfering with a movement of the rotating shooting stand 4. The power supply module 2 is a battery module detachably connected to the supporting base 7.

### Embodiment 9 (Not Shown in the Drawings)

In one embodiment, the power supply module 2 is installed on the rotating shooting stand 4 and is disposed adjacent to a connection joint between the rotating shooting stand 4 and the power output end of the driving device 3. The electrical conductor 5 is an electrical line (not shown). The electrical line is arranged along a length direction of the rotating shooting stand 4. A first end of the electrical line is electrically connected to at least one power output end of the power supply module 2. A charging plug matched with a charging interface of the at least one shooting device is disposed on a second end of the electrical line.

The power supply module 2 is adjacent to the connection joint between the rotating shooting stand 4 and the power output end of the driving device. Specifically, the power supply module 2 is installed on the second bracket 420. When the 360-degree photo booth is in operation, the power supply module 2 rotates together with the rotating shooting stand 4, which avoids an introduction of a heavy power bank placed at a position where the rotating shooting stand 4 holds the at least one shooting device, thereby avoiding an increase in weight at an overhanging end of the rotating shooting stand 4. Thus, the rotating shooting stand 4 does not shake during rotation, avoiding jittery image capture and poor quality. Furthermore, it prevents the heavy power bank from exceeding a rated load of the rotating shooting stand 4. The power bank and the shooting device connected via a charging wire may be flung out together under the action of centrifugal force, creating a hazard. By providing the power supply module 2, the heavy power bank is eliminated, and the safety of the 360-degree photo booth is improved.

The electrical line is arranged along the length direction of the rotating shooting stand 4 and does not become tangled or interfere with the supporting stage 1 or the supporting base 7. In a preferred layout, the power supply module 2 is disposed opposite to a first bracket 410 with the supporting spindle 6 configured as a boundary. The power supply module 2 is configured as a counterweight to balance the 360-degree photo booth and make the rotating shooting stand 4 more stable. The power supply module 2 is a battery module.

The battery comprises one or more rechargeable batteries.

In one embodiment, the supporting stage 1 further comprises a bearing layer 130. The bearing layer 130 is laid on an upper end surface of the supporting frame 110. The bearing layer 130, a peripheral edge of the supporting frame 110, and the light-transmitting supporting layer 120 are enclosed to define an installation area 140. The at least one solar panel is disposed in the installation area 140.

In some embodiments, the bearing layer 130 is a stainless steel plate, and an end surface of the bearing layer 130 facing the light-transmitting supporting layer 120 is a mirror surface.

On one hand, the bearing layer 130 is configured to cover the supporting frame 110 for aesthetic purposes and to support the at least one solar panel installed in the installation area 140. On the other hand, the end surface of the bearing layer 130 facing the light-transmitting supporting layer 120 is the mirror surface, so that the end surface of the bearing layer 130 is able to reflect light to provide fill light for the user standing on the light-transmitting supporting layer 120, thereby enhancing an imaging effect of the user.

When the light-transmitting supporting layer 120 is fully transparent or has a certain degree of transparency, decorative patterns are disposed on the bearing layer 130. The decorative patterns on the bearing layer 130 are able to be viewed through the light-transmitting supporting layer 120 to improve the aesthetics of the 360-degree photo booth. The bearing layer 130 may also be an ordinary plate without the decorative patterns.

As shown in FIGS. 1 and 5-7, the rotating shooting stand 4 comprises a first bracket 410, a second bracket 420, and an angle adjustment mechanism 430. The first bracket 410 and the second bracket 420 are rotatably connected through the angle adjustment mechanism 430. One end of the second bracket 420 away from the angle adjustment mechanism 430 is connected to the power output end of the driving device 3. The first bracket 410 comprises one or more shooting device connectors 440. The angle adjustment mechanism 430 comprises a rotating shaft 431, an elastic member 432, a pull pin 433, and two adjustment bases 434. A rotating groove 4341 is defined between the two adjustment bases 434. An end of the first bracket 410 extends into the rotating groove 4341, and the rotating shaft 431 passes through the two adjustment bases 434 and the first bracket 410, so that the first bracket 410 is hinged to the two adjustment bases 434. The adjustment bases 434 comprise arc-shaped slots 4342. Partition protrusions 4343 spaced apart from each other are disposed in each of the arc-shaped slots 4342 to divide each of the arc-shaped slots 4342 into positioning holes 4344. The first bracket 410 comprises an adjustment guide slot 411, and the adjustment guide slot 411 extends along a length direction of the first bracket 410. The pull pin 433 passes through the arc-shaped slots 4342 and the adjustment guide slot. An anti-detachment protrusion 4331 is disposed on an outer wall of the pull pin 433 located in the first bracket 410. A size of the anti-detachment protrusion 4331 is greater than an aperture of the adjustment guide slot 411. The elastic member 432 is disposed in the first bracket 410. Two ends of the elastic member 432 are respectively connected to the rotating shaft 431 and the pull pin 433 for maintaining the pull pin 433 close to the rotating shaft 431.

Conventional shooting stands typically use hand-tightened screws to adjust a rotation angle of the shooting stand and to achieve the disassembly and assembly of the first bracket 410 and the second bracket 420. Because the conventional shooting stands rely on screw connections, a connecting structure thereof is simple, and an ordinary user is able to unscrew the hand-tightened screws and separate the first bracket 410 from the second bracket 420. Different from the conventional shooting stands, the rotating shooting stand 4 of the present disclosure not only allows the user to adjust a rotation angle of the first bracket 410 relative to the second bracket 420 but also possesses an anti-theft function.

The first bracket 410 and the second bracket 420 are both telescopic brackets. Correspondingly, the connecting wire 450 of the electrical conductor 5 is also a connecting wire 450 with an elastic telescopic function.

When using the angle adjustment mechanism 430 to adjust the rotation angle of the first bracket 410 relative to the second bracket 420, the pull pin 433 extending out of the adjustment guide slot 411 and the arc-shaped slots 4342 is pulled by hand. The pull pin 433 overcomes an elastic force of the elastic member 432 and moves along the adjustment guide slot 411 in a direction away from the rotating shaft 431 until the pull pin 433 disengages from a corresponding one of the positioning holes 4344 defined by two corresponding adjacent partition protrusions 4343 and enters an area of the arc-shaped slots 4342 where no partition protrusions 4343 are disposed. At this time, the first bracket 410 rotates within a range of a curvature of the arc-shaped slots 4342 relative to the second bracket 420, with the rotating shaft 431 as a rotation center, so as to adjust a position of the first bracket 410.

After the rotation angle of the first bracket 410 is determined, the pull pin 433, which rotates together with the first bracket 410, reaches a current positioning hole 4344. The user only needs to release the pull pin 433, and under a pulling force of the elastic member 432, two ends of the pull pin 433 enter the current positioning hole 4344 and are caught and positioned by two partition protrusions 4343 on two sides of the current positioning hole.

In some embodiments, the elastic member 432 is a tension spring. One end of the adjustment guide slot 411 close to the rotating shaft 431 defines a mounting hole 4111 matched with an outer diameter of the anti-detachment protrusion 4331.

Therefore, when the 360-degree photo booth is deployed in entertainment venues or other locations as the shared device, the 360-degree photo booth inherently possesses a good anti-theft function to prevent others from removing the first bracket 410.

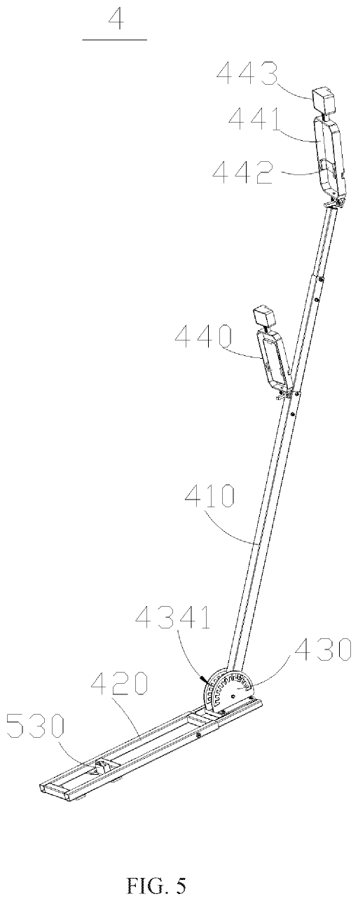

As shown in FIG. 5, each shooting device connector 440 comprises a protective outer frame 441, each protective outer frame 441 is rotatably connected to the first bracket 410, and an elastic holder 442 is disposed in each protective outer frame 441.

Optionally, an action camera 443 is disposed on an outer side of each protective outer frame 441.

In some embodiments, each action camera 443 is non-detachably and rotatably connected to a corresponding protective outer frame 441. When the 360-degree photo booth is deployed in entertainment venues or other locations as the shared device, the user does not need to provide his/her own professional action camera for shooting. The user can directly use any action camera 443 disposed on the 360-degree photo booth.

On one hand, each protective outer frame 441 provides protection for the elastic holder 442 thereof and limits a dimension of a smart device that is able to enter each protective outer frame 441 to be held by the elastic holder 442 thereof. On the other hand, each protective outer frame 441 is configured as a safeguard for the smart device, preventing a shooting device of the user from striking random external objects and being damaged while rotating together with the rotating shooting stand 4.

In some embodiments, each elastic holder 442 has an anti-theft lock. When the 360-degree photo booth is deployed as the shared device, at least one smart terminal (i.e., the at least one shooting device), such as at least one smartphone, is clamped by a corresponding elastic holder 442. The at least one smartphone has a built-in shared interaction program and a specialized photography and video recording program. By providing the anti-theft lock, the at least one smart terminal is clamped by a corresponding elastic holder 442, preventing the at least one smart terminal from being removed by others who do not have an unlocking key.

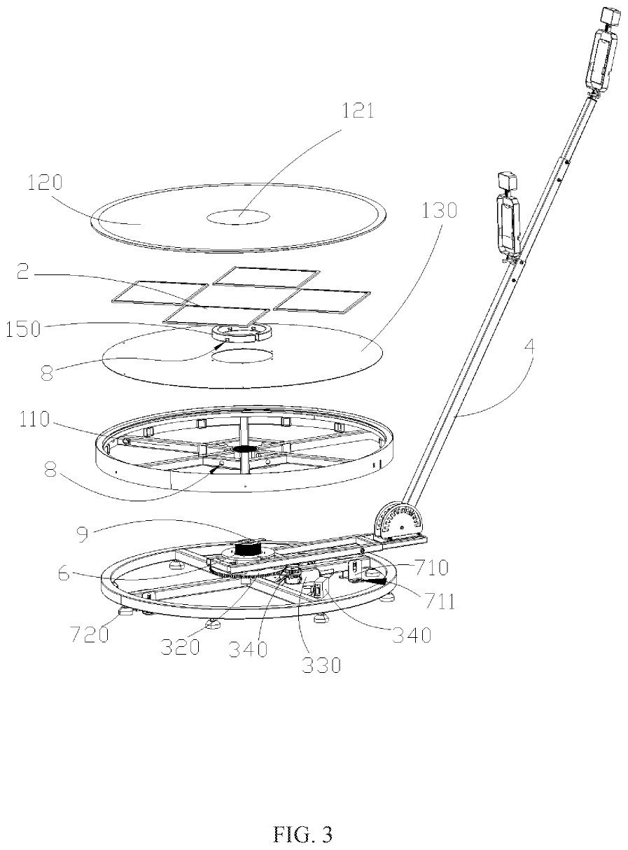

As shown in FIGS. 2-3, anti-theft connecting bases 710 are disposed on the supporting base 7. A first end of each of the anti-theft connecting bases 710 is adjustably connected to the supporting base 7. A connecting portion 711 configured to be fixed to a ground is disposed on a second end of each of the anti-theft connecting bases 710.

In some embodiments, foot cups 720 are disposed under the supporting base 7. The foot cups are configured to adjust a height of the 360-degree photo booth. Each of the anti-theft connecting bases 710 is an L-shaped plate. An elongated hole extending along a height direction of the 360-degree photo booth is defined on a long plate of each of the anti-theft connecting bases 710. Each of the anti-theft connecting bases 710 is adjustably connected to the supporting base 7 via a screw passing through the elongated hole thereof, corresponding to the height adjustment of the foot cups 720. The connecting portion 711 is a through hole designed on a short plate of each L-shaped plate. The short plate of each L-shaped plate is attached to the ground, and an expansion screw is provided to pass through each connecting portion 711 to fix the supporting base 7 to the ground, preventing the support base 7 from being moved or displaced. By such configurations, the 360-degree photo booth is suitable to be deployed as the shared device in public entertainment venues.

In one embodiment, the supporting stage 1 further comprises a supporting bracket 150. The supporting bracket 150 is disposed between the supporting frame 110 and the light-transmitting supporting layer 120. The supporting bracket is disposed substantially at a central position of the light-transmitting supporting layer 120. The light-transmitting supporting layer 120 comprises an opaque coating 121 corresponding to the supporting bracket 150.

The supporting bracket 150 supports the central portion of the light-transmitting supporting layer 120 to enhance a structural strength of the light-transmitting supporting layer 120 and extend service life of the light-transmitting supporting layer 120, preventing the light-transmitting supporting layer 120 from breaking due to stress distribution issues. The opaque coating 121 may be a pattern that covers the supporting bracket 150 at the central portion of the light-transmitting supporting layer 120 corresponding to the supporting bracket 150, thereby improving aesthetics.

In the above embodiments, the first conductive ring 510 and the second conductive ring 520 are installed on an insulating base 540 made of nylon. The first conductive ring 510 is spaced apart from the second conductive ring 520, so that the first conductive ring 510 and the second conductive ring 520 are not electrically connected to each other.

In Embodiment 7 and related embodiments where the power supply module 2 comprises the at least one solar panel disposed on the supporting stage 1 and the battery module disposed on the supporting base 7, a cable organizer 9 is disposed on an end port of the supporting spindle 6 where the supporting spindle 6 is connected to the supporting stage 1 to ensure clearer and more organized wiring. A base of the cable organizer 9 is connected to an upper end surface of the supporting frame 110. The cable organizer 9 comprises two metal connecting posts. The positive terminal and the negative power terminal of the at least one solar panel are respectively connected to the two metal connecting posts. Third routing through holes of the routing through holes 8 are defined in a side wall of the supporting bracket 150 to facilitate a connection between the cable organizer and the at least one solar panel. The first conductive ring 510 and the second conductive ring 520 are respectively connected to the two metal connecting posts through the electrical wires. The positive terminal and the negative terminal of the battery module disposed on the supporting base 7 enter the inner hole of the supporting spindle 6 through two of the electrical wires passing through the routing through hole 8 on the supporting base 7, and are then connected to the two metal connecting posts. The supporting base 7 comprises a cable tie bridge 730 for fixing the electrical wires.

In summary, through the various embodiments described above, when the 360-degree photo booth is configured as the shared device in entertainment venues, each power-consuming unit in the 360-degree photo booth is powered without employing the power line connected to the power outlet, which avoids a phenomenon of the power line being laid on the ground or suspended. If the power line is laid on the ground or suspended, other personnel passing by may be tripped, or the power line may be crushed, resulting in damage and the danger of electrical leakage. Furthermore, the 360-degree photo booth is able to supply power to and charge the at least one shooting device mounted on the rotating shooting stand 4 through the power supply module 2 and the electrical conductor 5, so that the user does not need to worry about the shooting device running out of power, and the shooting time is not limited. Through the ingenious structure of the electrical conductor 5 and the layout of the power supply module 2, the problem of the rotating shooting stand 4 shaking during operation caused by setting the heavy power bank on the rotating shooting stand 4 is overcome, and the problem of wire disorder and tangling as the electrical wires rotate and move with the rotating shooting stand 4 is avoided. Additionally, the power supply module 2 is disposed in the supporting stage 1 and/or the supporting base 7, which provides an anti-theft function.

What is claimed is:

1. A 360-degree photo booth, comprising:
a supporting stage;
a power supply module;
a driving device;
a rotating shooting stand; and
an electrical conductor;
wherein a first end of the rotating shooting stand is connected to a power output end of the driving device, and a second end of the rotating shooting stand is configured for mounting at least one shooting device;
wherein the driving device is configured to drive the rotating shooting stand to move around the supporting stage;
wherein the electrical conductor is electrically connected to the power supply module and configured to transmit electrical energy to the at least one shooting device mounted on the rotating shooting stand.

2. The 360-degree photo booth according to claim 1, wherein the power supply module is installed on the supporting stage, and the electrical conductor comprises a brush assembly, a first conductive ring, a second conductive ring, and a connecting wire;
wherein the first conductive ring and the second conductive ring are connected to a lower end surface of the supporting stage, and the first conductive ring and the second conductive ring are respectively connected to a positive terminal and a negative terminal of at least one power output end of the power supply module;
wherein the brush assembly is installed on the rotating shooting stand, and two elastic brush ends of the brush assembly respectively abut against the first conductive ring and the second conductive ring;
wherein the connecting wire is arranged along a length direction of the rotating shooting stand, a first end of the connecting wire is electrically connected to a power output end of the brush assembly, and a charging plug matched with a charging interface of the at least one shooting device is disposed on a second end of the connecting wire;
wherein central axes of the first conductive ring and the second conductive ring are substantially collinear with a central axis of the supporting stage and a rotating central axis of the rotating shooting stand.

3. The 360-degree photo booth according to claim 2, wherein the power supply module comprises at least one solar panel, the supporting stage comprises a supporting frame and a light-transmitting supporting layer, the at least one solar panel is disposed between the supporting frame and the light-transmitting supporting layer, and the first conductive ring and the second conductive ring are respectively electrically connected to a positive terminal and a negative terminal of a power output end of the at least one solar panel.

4. The 360-degree photo booth according to claim 1, wherein the 360-degree photo booth further comprises a supporting spindle and a supporting base;
wherein the supporting base is connected to the supporting stage through the supporting spindle, the power supply module is installed on the supporting base, and the driving device is electrically connected to the power supply module.

5. The 360-degree photo booth according to claim 4, wherein the supporting spindle is a hollow shaft, and the electrical conductor comprises a brush assembly, a first conductive ring, a second conductive ring, and a connecting wire;
wherein the first conductive ring and the second conductive ring are connected to a lower end surface of the supporting stage, and the first conductive ring and the second conductive ring are respectively connected to a positive terminal and a negative terminal of at least one power output end of the power supply module through electrical wires passing through an inner hole of the supporting spindle;
wherein the brush assembly is installed on the rotating shooting stand, and two elastic brush ends of the brush assembly respectively abut against the first conductive ring and the second conductive ring;
wherein the connecting wire is arranged along a length direction of the rotating shooting stand, a first end of the connecting wire is electrically connected to a power output end of the brush assembly, and a charging plug matched with a charging interface of the at least one shooting device is disposed on a second end of the connecting wire;
wherein central axes of the first conductive ring and the second conductive ring are substantially collinear with a central axis of the supporting stage, a rotating central axis of the rotating shooting stand, and a central axis of the supporting spindle.

6. The 360-degree photo booth according to claim 5, wherein the power supply module comprises at least one solar panel and a battery module installed on the supporting base;
wherein the supporting stage comprises a supporting frame and a light-transmitting supporting layer, the at least one solar panel is disposed between the supporting frame and the light-transmitting supporting layer, and the first conductive ring and the second conductive ring are respectively electrically connected to a positive terminal and a negative terminal of a power output end of the at least one solar panel.

7. The 360-degree photo booth according to claim 1, wherein the 360-degree photo booth further comprises a supporting base;
wherein the power supply module is installed on the supporting base; the driving device is electrically connected to the power supply module, or the driving device is not connected to the power supply module;
wherein the electrical conductor comprises a brush assembly, a first conductive ring, a second conductive ring, and a connecting wire;
wherein the first conductive ring and the second conductive ring are connected to an upper end surface of the supporting base;
wherein the brush assembly is installed on the rotating shooting stand, and two elastic brush ends of the brush assembly respectively abut against the first conductive ring and the second conductive ring;
wherein the connecting wire is arranged along a length direction of the rotating shooting stand, a first end of the connecting wire is electrically connected to a power output end of the brush assembly, and a charging plug matched with a charging interface of the at least one shooting device is disposed on a second end of the connecting wire;
wherein central axes of the first conductive ring and the second conductive ring are substantially collinear with a central axis of the supporting stage, a central axis of the supporting base, and a rotating central axis of the rotating shooting stand.

8. The 360-degree photo booth according to claim 1, wherein the power supply module is installed on the rotating shooting stand and is disposed adjacent to a connection joint between the rotating shooting stand and the power output end of the driving device;
wherein the electrical conductor is an electrical line, the electrical line is arranged along a length direction of the rotating shooting stand, a first end of the electrical line is electrically connected to at least one power output end of the power supply module, and a charging plug matched with a charging interface of the at least one shooting device is disposed on a second end of the electrical line.

9. The 360-degree photo booth according to claim 3, wherein the supporting stage further comprises a bearing layer, the bearing layer is laid on an upper end surface of the supporting frame, and the bearing layer, a peripheral edge of the supporting frame, and the light-transmitting supporting layer are enclosed to define an installation area, and the at least one solar panel is disposed in the installation area.

10. The 360-degree photo booth according to claim 6, wherein the supporting stage further comprises a bearing layer, the bearing layer is laid on an upper end surface of the supporting frame, and the bearing layer, a peripheral edge of the supporting frame, and the light-transmitting supporting layer are enclosed to define an installation area, and the at least one solar panel is disposed in the installation area.

11. The 360-degree photo booth according to claim 1, wherein the rotating shooting stand comprises a first bracket, a second bracket, and an angle adjustment mechanism;
wherein the first bracket and the second bracket are rotatably connected through the angle adjustment mechanism, and one end of the second bracket away from the angle adjustment mechanism is connected to the power output end of the driving device;
wherein the first bracket comprises one or more shooting device connectors;
wherein the angle adjustment mechanism comprises a rotating shaft, an elastic member, a pull pin, and two adjustment bases;
a rotating groove is defined between the two adjustment bases, an end of the first bracket extends into the rotating groove, and the rotating shaft passes through the two adjustment bases and the first bracket, so that the first bracket is hinged to the two adjustment bases;
wherein the adjustment bases comprise arc-shaped slots, and partition protrusions spaced apart from each other are disposed in each of the arc-shaped slots to divide each of the arc-shaped slots into positioning holes;
wherein the first bracket comprises an adjustment guide slot, and the adjustment guide slot extends along a length direction of the first bracket;
wherein the pull pin passes through the arc-shaped slots and the adjustment guide slot, and an anti-detachment protrusion is disposed on an outer wall of the pull pin located in the first bracket, and a size of the anti-detachment protrusion is greater than an aperture of the adjustment guide slot;
wherein the elastic member is disposed in the first bracket, and two ends of the elastic member are respectively connected to the rotating shaft and the pull pin for maintaining the pull pin close to the rotating shaft.

12. The 360-degree photo booth according to claim 11, wherein each shooting device connector comprises a protective outer frame, each protective outer frame is rotatably connected to the first bracket, and an elastic holder is disposed in each protective outer frame.

13. The 360-degree photo booth according to claim 3, wherein the 360-degree photo booth further comprises a supporting base, anti-theft connecting bases are disposed on the supporting base, a first end of each of the anti-theft connecting bases is adjustably connected to the supporting base, and a connecting portion configured to be fixed to a ground is disposed on a second end of each of the anti-theft connecting bases.

14. The 360-degree photo booth according to claim 6, wherein anti-theft connecting bases are disposed on the supporting base, a first end of each of the anti-theft connecting bases is adjustably connected to the supporting base, and a connecting portion configured to be fixed to a ground is disposed on a second end of each of the anti-theft connecting bases.

15. The 360-degree photo booth according to claim 3, wherein the supporting stage further comprises a supporting bracket, the supporting bracket is disposed between the supporting frame and the light-transmitting supporting layer, the supporting bracket is disposed substantially at a central position of the light-transmitting supporting layer, and the light-transmitting supporting layer comprises an opaque coating corresponding to the supporting bracket.

16. The 360-degree photo booth according to claim 6, wherein the supporting stage further comprises a supporting bracket, the supporting bracket is disposed between the supporting frame and the light-transmitting supporting layer, the supporting bracket is disposed substantially at a central position of the light-transmitting supporting layer, and the light-transmitting supporting layer comprises an opaque coating corresponding to the supporting bracket.
